(19) United States
(12) Patent Application Publication
(10) Pub. No.: US 2024/0346444 A1
(43) Pub. Date: Oct. 17, 2024

(54) RACK INVENTORY TRACKING SYSTEM USING CAMERA AND OPERATING METHOD THEREOF

(71) Applicants: Hyundai Motor Company, Seoul (KR); Kia Corporation, Seoul (KR)

(72) Inventors: Sunjoo Moon, Suwon (KR); Wonseok Choi, Seongnam (KR); Hyejun Park, Seoul (KR)

(21) Appl. No.: 18/636,018

(22) Filed: Apr. 15, 2024

(30) Foreign Application Priority Data
Apr. 14, 2023 (KR) 10-2023-0049216
Jul. 4, 2023 (KR) 10-2023-0086218

(51) Int. Cl. G06Q 10/087; G06V 10/44; G06V 20/52

(52) U.S. Cl. CPC G06Q 10/087; G06V 10/44; G06V 20/52

(57) ABSTRACT

A rack inventory tracking system includes: a camera that acquires an image of a rack; a computing device that receives the image from the camera, distinguishes a plurality of rack storage areas in the image, and performs object recognition on the plurality of rack storage areas to determine whether an article is present in the plurality of rack storage areas; and a logistics management server that performs inventory tracking on the plurality of rack storage areas by comparing the presence of the article in the plurality of rack storage areas with a rack inventory status stored in a database.

### CROSS-REFERENCE TO RELATED APPLICATION

This application claims under 35 U.S.C. § 119 (a) the benefit of Korean Patent Application No. 10-2023-0049216 filed in the Korean Intellectual Property Office on Apr. 14, 2023, and Korean Patent Application No. 10-2023-0086218 filed in the Korean Intellectual Property Office on Jul. 4, 2023, the entire contents of which are incorporated herein by reference.

### BACKGROUND

### (a) Technical Field

The present disclosure relates to a rack inventory tracking system using a camera, and an operating method of the rack inventory tracking system.

### (b) Description of the Related Art

Stocking and releasing articles into and out of a distribution center typically may be accomplished manually by workers. If a worker omits information about the stocked/released articles, or the stocked/released articles otherwise are not accounted for, it may lead to inventory shortages in logistics management. In order to detect missing inventory, additional work is required to conduct inventory counts. Inventory counting may reduce the efficiency of logistics management.

### SUMMARY

The present disclosure provides a rack inventory tracking system configured to automatically find inventory errors.

An exemplary embodiment of the present disclosure provides a rack inventory tracking system including: a camera configured to acquire an image of a rack; a computing device configured to receive an image acquired from the camera, distinguish a plurality of rack storage areas in the image, and perform object recognition on the plurality of rack storage areas to determine whether an article is present in the plurality of rack storage areas; and a logistics management server configured to perform inventory tracking on the plurality of rack storage areas by comparing the presence of the article in the plurality of rack storage areas with a rack inventory status stored in a database.

The computing device may include a processor configured to set an initial image for an initial state where there is no article in the rack as a master image, and recognizing the rack in the master image to set a zone to be used for storing an article.

The processor may set a plurality of rack storage areas by dividing the zone into a plurality of areas, and perform edge recognition on the zone by using image data received from the camera at predetermined monitoring intervals, and determine which of the plurality of rack storage areas the recognized edge corresponds to.

The processor may generate an object recognition rate that is a ratio of a size defined by a corresponding edge to a size of a rack storage area in an initial state of each of the plurality of rack storage areas, and determine that an article is present in each of the rack storage areas when the object recognition rate within each rack storage area is equal to or greater than a predetermined threshold, and determine that an article is not present in each of the rack storage areas when the object recognition rate is less than a predetermined threshold.

The processor may determine that an article is present in any one of the plurality of rack storage areas when the recognized edge corresponding to any one of the plurality of rack storage areas is maintained for a predetermined period of time.

The processor may calculate an object recognition rate in each rack storage area for the recognized edge when the recognized edge is located over two rack storage areas of the plurality of rack storage areas, and determine that an article is present in the rack storage area of the two rack storage areas with a higher object recognition rate.

The logistics management server may compare an article recognition result received from the computing device with the rack inventory status stored in the database, determine that the rack inventory status is normally tracked when the article recognition result received from the computing device matches the rack inventory status stored in the database as a result of the comparison, and notify a terminal of a worker who has performed work on the mismatched rack storage area of a work error when the article recognition result received from the computing device does not match the rack inventory status stored in the database as a result of the comparison.

The logistics management server may store a work error history for each worker, and notify an administrator terminal of a repeat of a work error of a specific worker when the specific worker repeats a work error a predetermined number of times or more.

The logistics management server may receive, from the computing device, object recognition for a first rack storage area based on a change in state of the first rack storage area where an article is not present, receive article information corresponding to the object through a worker terminal, and check whether the received article information is information about an article to be stocked stored in a database of the logistics management server, and whether a stocking location matched to the article to be stocked in the database matches a location of the first rack storage area.

The logistics management server may notify a worker terminal and/or administrator terminal of a worker who performed stocking work of a failure of the stocking work when the stocking location does not match the location of the first rack storage area.

The logistics management server may instruct a worker terminal, a camera attached to equipment, or a CCTV located proximate to the stocking location to photograph a rack storage area corresponding to the stocking location and transmit the photographed rack storage area to the computing device, and receive a result of determining whether an object is recognized for the first rack storage area from the computing device.

Another exemplary embodiment of the present disclosure provides a method of operating a rack inventory tracking system including a camera for acquiring an image of a rack and a processor performing rack inventory tracking by using an image acquired from the camera, the method including: distinguishing, by a computing device, a plurality of rack storage areas in the image acquired from the camera; performing, by the computing device, object recognition on the plurality of rack storage areas to determine whether an article is present in the plurality of rack storage areas; and checking, by a logistics management server, an inventory status of the plurality of rack storage areas by comparing the presence of the article in the plurality of rack storage areas with a rack inventory status stored in a database.

The distinguishing of the plurality of rack storage areas may include: setting an initial image for an initial state where there is no article in the rack as a master image, and recognizing the rack in the master image to set a zone to be used for storing an article; and setting a plurality of rack storage areas by dividing the zone into a plurality of areas.

The determining of whether the article is present in the plurality of rack storage areas may include: performing edge recognition on the zone by using image data received from the camera at predetermined monitoring intervals; and determining which of the plurality of rack storage areas the recognized edge corresponds to.

The determining of which of the plurality of rack storage areas the recognized edge corresponds to may include: generating an object recognition rate that is a ratio of a size defined by a corresponding edge to a size of a rack storage area in an initial state of each of the plurality of rack storage areas; determining that an article is present in each of the rack storage areas when the object recognition rate within each rack storage area is equal to or greater than a predetermined threshold; and determining that an article is not present in each of the rack storage areas when the object recognition rate is less than a predetermined threshold.

The determining of which of the plurality of rack storage areas the recognized edge corresponds to may further include determining that an article is present in any one of the plurality of rack storage areas when the recognized edge corresponding to any one of the plurality of rack storage areas is maintained for a predetermined period of time.

The determining of which of the plurality of rack storage areas the recognized edge corresponds to may further include: calculating an object recognition rate in each rack storage area for the recognized edge when the recognized edge is located over two rack storage areas of the plurality of rack storage areas; and determining that an article is present in the rack storage area of the two rack storage areas with a higher object recognition rate.

The checking of the inventory status of the plurality of rack storage areas may include: comparing an article recognition result by the computing device with the rack inventory status stored in the database; determining that the rack inventory status is normally tracked when the article recognition result received from the computing device matches the rack inventory status stored in the database as a result of the comparison; and notifying a terminal of a worker who has performed work on the mismatched rack storage area of a work error when the article recognition result received from the computing device does not match the rack inventory status stored in the database as a result of the comparison.

The method may further include storing a work error history for each worker, and notifying an administrator terminal of a repeat of a work error of a specific worker when the specific worker repeats a work error a predetermined number of times or more.

According to another exemplary embodiment, a non-transitory computer readable medium containing program instructions executed by a processor may include: program instructions that distinguish a plurality of rack storage areas in an image acquired from a camera; program instructions that perform object recognition on the plurality of rack storage areas to determine whether an article is present in the plurality of rack storage areas; and program instructions that check an inventory status of the plurality of rack storage areas by comparing the presence of the article in the plurality of rack storage areas with a rack inventory status stored in a database.

The present disclosure provides the rack inventory tracking system capable of automatically tracking rack inventory by using a camera, and the operating method of the rack inventory tracking system.

### BRIEF DESCRIPTION OF THE DRAWINGS

FIG. 1 is a diagram illustrating a rack inventory tracking system according to an exemplary embodiment.

FIG. 2 is a diagram illustrating a master image acquired by a camera.

FIG. 3 is a diagram illustrating a plurality of rack storage areas in the master image.

FIG. 4 is a flowchart illustrating a method of operating a rack inventory tracking system according to an exemplary embodiment.

FIG. 5 is a diagram illustrating edge recognition results in a plurality of rack storage areas.

FIG. 6 is a flowchart illustrating an operation of a logistics management server according to an exemplary embodiment.

### DETAILED DESCRIPTION OF THE EXEMPLARY EMBODIMENTS

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

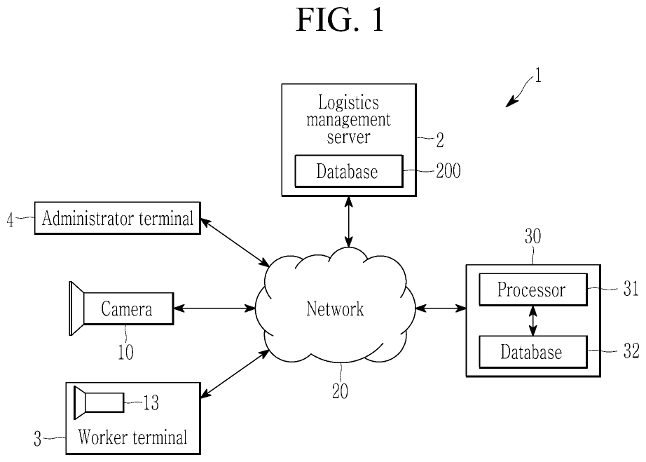

FIG. 1 is a diagram illustrating a rack inventory tracking system according to an exemplary embodiment.

As illustrated in FIG. 1, a system 1 may include a logistics management server 2, a camera 10, and a computing device 30. The computing device 30 may include a processor 31 and a memory 32. The logistics management server 2, a worker terminal 3, an administrator terminal 4, the camera 10, and the computing device 30 may transmit and receive information through a network 20. Although not illustrated in FIG. 1, the logistics management server 2, the worker terminal 3, the administrator terminal 4, the camera 10, and the computing device 30 may include transmitting and receiving devices capable of transmitting and receiving information through the network 20. The network 20 may be implemented as a wired network, a wireless network, a combination thereof, or the like, and may be implemented in a variety of ways depending on the system design. Information may be transmitted and received between at least two configurations of the logistics management server 2, the worker terminal 3, the administrator terminal 4, the camera 10, and the computing device 30 through the network 20. In addition, information may be transmitted and received to and from the outside of the system 1 through the network 20. The worker terminal 3 may include a camera 13. In FIG. 1, a rack image may be acquired through the camera 13 provided on the worker terminal 3 in the same manner as the camera 10.

The administrator terminal 4 may request and receive information necessary for logistics management from the logistics management server 2, or may transmit a work list for a worker to the logistics management server 2. Further, the logistics management server 2 may transmit information about a work error of any worker to the worker terminal 3 and/or the administrator terminal 4.

The logistics management server 2 may request data for rack inventory tracking from the computing device 30 through the network 20, and the computing device 30 may collect and process the requested data and provide the processed data to the logistics management server 2 through the network 20. The logistics management server 2 may perform rack inventory tracking based on the data received from the computing device 30. In FIG. 1, the computing device 30 is separate from the logistics management server 2, but the logistics management server 2 may include the computing device 30. In this case, the image data acquired from the camera 10 may be transmitted to the logistics management server 2 through the network 20. The logistics management server 2 may include a database 200 that stores rack inventory status. The rack inventory status stored in the database 200 may be based on stocking data and releasing data transmitted by the worker to the logistics management server 2 through the worker terminal 3. Stocking data may include information about articles stocked and locations of the stocked articles, and releasing data may include information about articles released and locations of the released articles.

The camera 10 may photograph a specific area, convert the photographed image to image data, and transmit the converted image data to the computing device 30 through the network 20. The specific area may be an area required for rack inventory tracking. The image data may be digital image data. The image data received by the computing device 30 through the network 20 may be provided to the processor 31. The processor 31 may process the image data to determine the rack inventory status. The processor 31 may generate control instructions to control the operation of the camera 10, if necessary, and transmit the control instructions to the camera 10 through the network 20.

The camera 10 may be fixedly positioned in a location suitable for photographing so that the entire rack is visible. Alternatively, an image of the entire rack may be acquired by the camera 13 provided on the worker terminal 3. That is, the worker may photograph the rack directly by using the camera 13. The computing device 30 may transmit a photographing instruction, along with information about the rack to be photographed, to the worker terminal 3 through the network 20. The worker may photograph the entire rack to be photographed by using the camera 13 according to the instruction, and transmit the corresponding image to the computing device 30 through the network 20.

Alternatively, the camera 10 may be mounted on moving equipment (forklift, rental, AGV, and the like) within a logistics center. The computing device 30 may transmit movement instructions, along with information about the rack to be photographed, to the worker terminal 3 of the worker operating the equipment through the network 20. The worker may move to the rack to be photographed according to the instruction. After the equipment is moved, the camera 10 may photograph the rack to be photographed and transmit the corresponding image to the computing device 30 through the network 20.

The processor 31 may receive the image data acquired from the cameras 10 and 13 through the network 20. The processor 31 may store the received image data in the memory 32. Additionally, the processor 31 may store data in the memory 32 that is necessary to determine the rack inventory status. The processor 31 may read the data required for data processing from the memory 32. The memory 32 may store programs required by the processor 31 to process data. For example, the processor 31 executes a program for recognizing objects in the image data and calculating a recognition rate, and the corresponding program may be stored in the memory 32.

The processor 31 may transmit control instructions to the camera 10 for obtaining image data of an initial state of the rack (initial image data). The initial state of the rack refers to a state in which there are no articles in the rack. The camera 10 may acquire the initial image data according to the control instruction and transmit the acquired initial image data to the processor 31. Alternatively, the processor 31 may transmit control instructions to the worker terminal 3 for acquiring the initial image data. The worker may acquire the initial image data by using the camera 13 and transmit the acquired initial image data to the processor 31 through the worker terminal 3. The processor 31 may define the initial image data as image data in a master state (hereinafter, the master image data), and set the initial image as a master image.

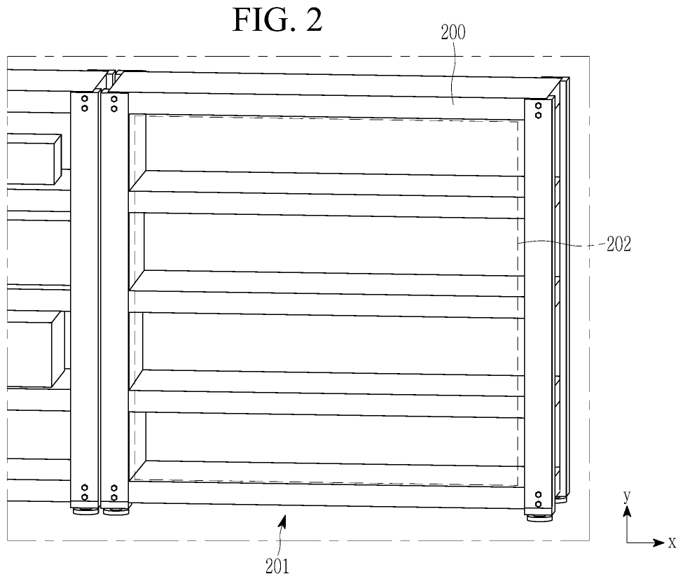

FIG. 2 is a diagram illustrating a master image acquired by a camera.

The master image illustrated in FIG. 2 may be acquired by the cameras 10 and 13. As illustrated in FIG. 2, the processor 31 may recognize a rack 200 in a master image 201 and establish a zone 202 to be used for storing articles in the recognized rack 200. The method of recognizing, by the processor 31, the rack 200 in the master image 201 may be implemented through a variety of object recognition techniques.

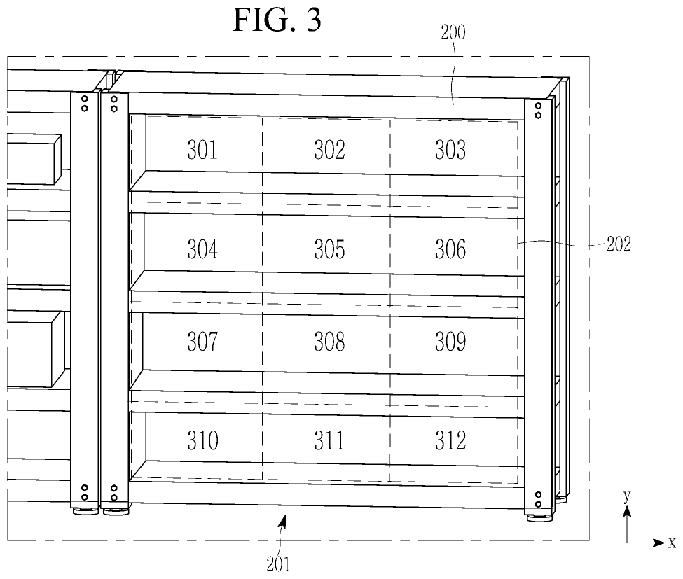

FIG. 3 is a diagram illustrating a plurality of rack storage areas in the master image.

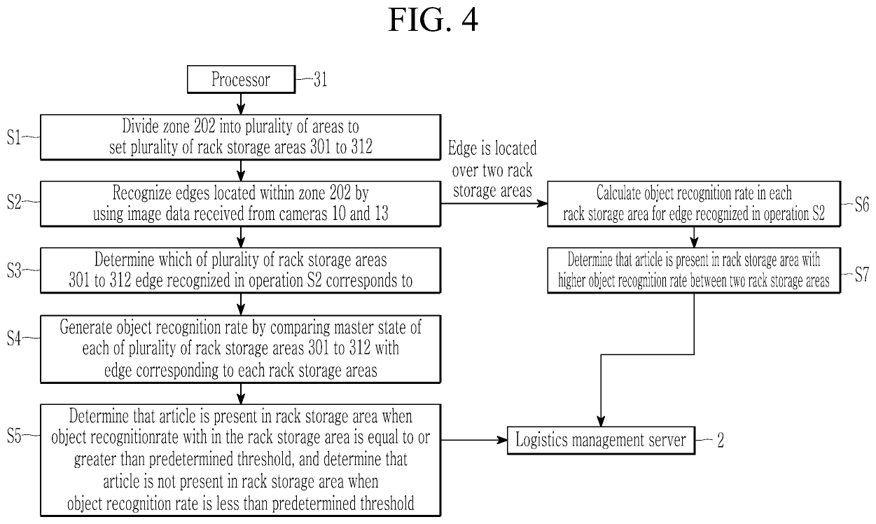

FIG. 4 is a flowchart illustrating a method of operating the rack inventory tracking system according to an exemplary embodiment.

As illustrated in FIG. 3, the processor 31 may divide the zone 202 into a plurality of areas to set a plurality of rack storage areas 301 to 312 (S1). The processor 31 may divide the zone 202 into the plurality of rack storage areas 301 to 312 based on a preset condition. For example, as illustrated in FIG. 3, the processor 31 may recognize that the rack in zone 202 is a four-story structure, and may divide the horizontal length of the rack (the x-axis directional length in FIG. 3) into three compartments based on the size of the articles to be stored in the rack. The processor 31 may divide the zone 202 into a 4×3 matrix to create the plurality of rack storage areas 301 to 312. The size of the plurality of rack storage areas 301 to 312 illustrated in FIG. 3 is an example, and the present disclosure is not limited thereto. The processor 31 may adjust the size of each of the plurality of rack storage areas 301 to 312 based on the setting conditions, external inputs, and the like.

Based on the image data received from the cameras 10 and 13, the processor 31 may monitor the status of the rack 200 in real time and determine whether an article is present in the plurality of rack storage areas 301 to 312 to generate article presence information. The processor 31 may transmit the article presence information to the logistics management server 2.

The processor 31 may recognize edges located within the zone 202 by using the image data received from the cameras 10 and 13 at predetermined monitoring intervals (S2). The processor 31 may analyze the image data received from the camera 10 with an object recognition program to detect edges. The object recognition program may be a program implementing various edge detection methods known in the art.

The processor 31 may determine which of the plurality of rack storage areas 301 to 312 the edge recognized in operation S2 corresponds to (S3). For example, the processor 31 may determine a rack storage area in which the recognized edge is located based on the size and the location of the recognized edge among the plurality of rack storage areas 301 to 312. The processor 31 may determine that the edge corresponds to a rack storage area if the edge is located within any rack storage area. When there is a plurality of edges recognized in operation S2, the processor 31 may determine a plurality of rack storage areas corresponding to the plurality of edges by determining, for each of the plurality of edges, the rack storage area in which the edge is located among the plurality of rack storage areas 301 to 312.

The processor 31 may generate an object recognition rate by comparing the master state of each of the plurality of rack storage areas 301 to 312 with the edge corresponding to each rack storage area (S4). For example, the processor 31 may generate a ratio of the size of the area defined by the corresponding edge to the size of the rack storage area in the master state as an object recognition rate. In this case, the sizes of the rack storage area and the area defined by the edge may refer to the sizes in three dimensions or in a plane.

The processor 31 may determine that an article is present in a rack storage area when the object recognition rate within the rack storage area is equal to or greater than a predetermined threshold, and determine that an article is not present in the rack storage area when the object recognition rate is less than the predetermined threshold (S5). The predetermined threshold may be 5% or may be changed depending on design.

When the edge recognized in operation S2 is located across two of the plurality of rack storage areas 301 to 312, the processor 31 may calculate an object recognition rate in each rack storage area for the edge recognized in operation S2 (S6).

The processor 31 may determine that an article is present in the rack storage area with the higher object recognition rate between the two rack storage areas (S7).

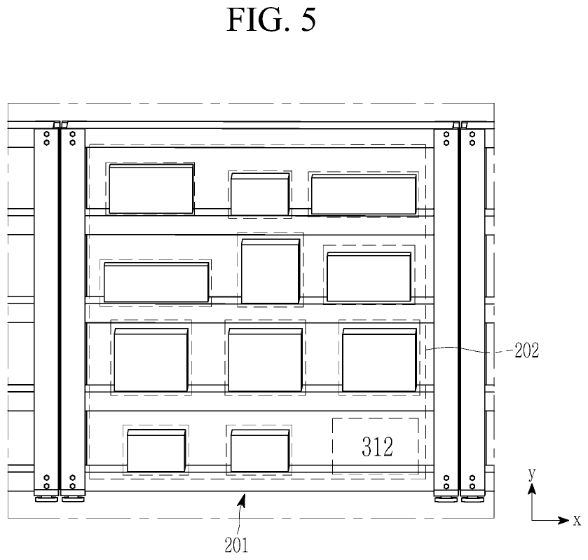

FIG. 5 is a diagram illustrating edge recognition results in a plurality of rack storage areas.

As illustrated in FIG. 5, the processor 31 may recognize a plurality of edges (for example, 401 in FIG. 5) in the plurality of rack storage areas 301 to 311 of the plurality of rack storage areas 301 to 312 to determine that a plurality of articles is present in the plurality of rack storage areas 301 to 311. The processor 31 fails to recognize an edge in the rack storage area 312 and determines that there are no articles in the rack storage area 312.

The processor 31 may transmit the article recognition results for the plurality of rack storage areas 301 to 312 to the logistics management server 2 through the network 20. The processor 31 may generate the article recognition results for the plurality of rack storage areas 301 to 312 at predetermined time intervals and transmit the generated article recognition results to the logistics management server 2. The logistics management server 2 may detect inventory status errors by comparing the article recognition result with the inventory status recorded in the database 200.

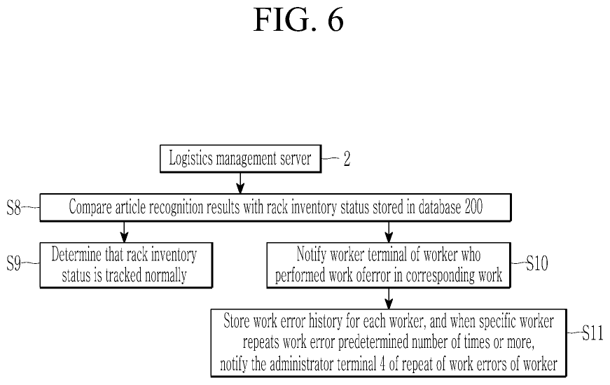

An object moving within the logistics center, such as a worker or a forklift, may be included in the image acquired from the camera 10, which may be mistaken for the presence of articles in a particular rack storage area. To prevent this, the processor 31 may determine that an article is present in the corresponding rack storage area when the recognized edge corresponding to each of the plurality of rack storage areas 301 to 312 is maintained for a predetermined period of time. The processor 31 may continuously monitor the article recognition rate in a specific rack storage area among the plurality of rack storage areas 301 to 312 a predetermined number of times, and determine that an article is present in the corresponding rack storage area when the object recognition rate in the specific rack storage area among the plurality of rack storage areas 301 to 312 is equal to or greater than the threshold. The predetermined period of time may be 2 seconds and may be changed depending on design. FIG. 6 is a flowchart illustrating an operation of the logistics management server according to an exemplary embodiment.

The logistics management server 2 may compare the article recognition results received from the computing device 30 with the rack inventory status stored in the database 200 (S8). The rack inventory status stored in the database 200 may include data about the presence or absence of an article for each rack location. For work that changes the inventory status of a rack, such as stocking or releasing an article, the worker may input the location of the rack into the worker terminal 3 or scan a QR code that indicates a location of the rack and and input the QR code to the worker terminal 3. Information about the rack location acquired by the worker terminal 3 may be transmitted to the logistics management server 2. Alternatively, when an image of the rack is acquired through a camera attached to equipment in the logistics center, the rack location information may be acquired by the corresponding equipment in a manner similar to the acquisition of the rack location by the worker terminal 3.

Upon stocking an article, the logistics management server 2 may compare the rack storage area in which the article to be stocked is recognized among the plurality of rack storage areas 301 to 312 with a stocking location in the database 200. The status of the rack storage area that had no articles is changed, and the processor 31 may recognize the object in the corresponding rack storage area and transmit the object recognition result to the logistics management server 2. The logistics management server 2 may receive article information for the corresponding object from the worker terminal 3, and verify whether the received article information is information about the article to be stocked stored in the database 200, and whether the stocking location matched to the article to be stocked in the database 200 matches the location of the rack storage area received from the processor 31.

When the stocking location matched to the article to be stocked in the database 200 does not match the location of the rack storage area received from the processor 31, the logistics management server 2 may notify the worker terminal and/or the administrator terminal of the worker who performed the stocking operation of the failure of the stocking work. When the stocking location matched to the article to be stocked in the database 200 matches the location of the rack storage area received from the processor 31, the logistics management server 2 may terminate stocking confirmation work.

In addition, the logistics management server 2 may instruct a worker terminal located proximate to the stocking location, a camera attached to the equipment, a CCTV, and the like., to photograph a rack storage area corresponding to the stocking location and transmit the photographed rack storage area to the computing device 30 in order to check the stocking location of the stocked article. The computing device 30 may transmit to the logistics management server 2 whether an object is recognized in the rack storage area corresponding to the stocking location through image data acquired from the worker terminal, the camera attached to the equipment, CCTV, or the like. When the computing device 30 has recognized the object, the logistics management server 2 may determine that the object has been properly stocked.

When the article recognition results received from the computing device 30 matches the rack inventory status stored in the database 200 as a result of the comparison in operation S8, the logistics management server 2 may determine that the rack inventory status is tracked normally (S9).

When the article recognition results received from the computing device 30 does not match the rack inventory status stored in the database 200 as a result of the comparison in operation S8, the logistics management server 2 may notify the worker terminal 3 of the worker who performed the corresponding work on the mismatched rack storage area of the error in the corresponding work (S10). The logistics management server 2 may transmit a work error notification to the worker terminal 3 carried by the worker. For example, if an article recognition result is the presence of an article in a certain rack storage area, and information about the article in that rack storage area exists in the database 200, the logistics management server 2 may take no further action. When the article recognition result indicates that the article is present in the specific rack storage area and there is no information about the article in the corresponding rack storage area in the database 200, or when the article is not present in the specific rack storage area and there is information about the article in the corresponding rack storage area in the database 200, the logistics management server 2 may transmit to the worker terminal that there is an error in the work.

The logistics management server 2 stores a work error history for each worker, and when a specific worker repeats a work error a predetermined number of times or more, the logistics management server 2 may notify the administrator terminal 4 of the repeat of the work errors of the worker (S11).

By tracking the status of rack inventory in integrated logistics center management, it is possible to reduce inventory errors and improve inventory information accuracy. As inventory accuracy improves, inventory counting is not required to improve work efficiency. The system notifies the work error of the worker to minimize worker human error. Since inventory may be tracked by using cameras, the disclosure may be combined with logistics center automation technology to improve logistics center productivity.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

What is claimed is:

1. A rack inventory tracking system comprising:
a camera configured to acquire an image of a rack;
a computing device configured to receive the image from the camera, distinguish a plurality of rack storage areas in the image, and perform object recognition on the plurality of rack storage areas to determine whether an article is present in the plurality of rack storage areas; and
a logistics management server configured to perform inventory tracking on the plurality of rack storage areas by comparing the presence of the article in the plurality of rack storage areas with a rack inventory status stored in a database.

2. The rack inventory tracking system of claim 1, wherein the computing device includes:
a processor configured to set an initial image for an initial state where there is no article in the rack as a master image, and recognize the rack in the master image to set a zone to be used for storing the article.

3. The rack inventory tracking system of claim 2, wherein the processor sets the plurality of rack storage areas by dividing the zone into a plurality of areas, and performs edge recognition on the zone by using image data received from the camera at predetermined monitoring intervals, and determines which of the plurality of rack storage areas the recognized edge corresponds to.

4. The rack inventory tracking system of claim 3, wherein the processor generates an object recognition rate that is a ratio of a size defined by a corresponding edge to a size of each rack storage area in an initial state of each of the plurality of rack storage areas, and determines that the article is present in each of the rack storage areas when the object recognition rate within each rack storage area is equal to or greater than a predetermined threshold, and determines that the article is not present in each of the rack storage areas when the object recognition rate is less than a predetermined threshold.

5. The rack inventory tracking system of claim 3, wherein the processor determines that the article is present in any one of the plurality of rack storage areas when the recognized edge corresponding to the one of the plurality of rack storage areas is maintained for a predetermined period of time.

6. The rack inventory tracking system of claim 3, wherein the processor calculates an object recognition rate in each rack storage area for the recognized edge when the recognized edge is located over two rack storage areas of the plurality of rack storage areas, and determines that the article is present in the rack storage area of the two rack storage areas with a higher object recognition rate.

7. The rack inventory tracking system of claim 1, wherein the logistics management server:
compares an article recognition result received from the computing device with the rack inventory status stored in the database,
determines that the rack inventory status is normally tracked when the article recognition result received from the computing device matches the rack inventory status stored in the database as a result of the comparison, and
notifies a terminal of a worker who has performed work on the mismatched rack storage area of a work error when the article recognition result received from the computing device does not match the rack inventory status stored in the database as a result of the comparison.

8. The rack inventory tracking system of claim 7, wherein the logistics management server stores a work error history for each worker, and notifies an administrator terminal of a repeat of a work error of a specific worker when the specific worker repeats a work error a predetermined number of times or more.

9. The rack inventory tracking system of claim 1, wherein the logistics management server receives, from the computing device, object recognition for a first rack storage area based on a change in state of the first rack storage area where the article is not present, receives article information corresponding to an object through a worker terminal, and checks whether the received article information is information about the article to be stocked stored in a database of the logistics management server, and whether a stocking location matched to the article to be stocked in the database matches a location of the first rack storage area.

10. The rack inventory tracking system of claim 9, wherein: the logistics management server notifies a worker terminal or administrator terminal of a worker who performed stocking work of a failure of the stocking work when the stocking location does not match the location of the first rack storage area.

11. The rack inventory tracking system of claim 9, wherein the logistics management server:
instructs the worker terminal, the camera attached to equipment, or a CCTV located proximate to the stocking location to photograph a rack storage area corresponding to the stocking location and transmit the photographed rack storage area to the computing device, and
receives a result of determining whether the object is recognized for the first rack storage area from the computing device.

12. A method of operating a rack inventory tracking system including a camera configured to acquire an image of a rack and a processor configured to perform rack inventory tracking by using the image from the camera, the method comprising:
distinguishing, by a computing device, a plurality of rack storage areas in the image acquired from the camera;
performing, by the computing device, object recognition on the plurality of rack storage areas to determine whether an article is present in the plurality of rack storage areas; and
checking, by a logistics management server, an inventory status of the plurality of rack storage areas by comparing the presence of the article in the plurality of rack storage areas with a rack inventory status stored in a database.

13. The method of claim 12, wherein distinguishing the plurality of rack storage areas includes:
setting an initial image for an initial state where there is no article in the rack as a master image, and recognizing the rack in the master image to set a zone to be used for storing the article; and
setting a plurality of rack storage areas by dividing the zone into a plurality of areas.

14. The method of claim 13, wherein determining whether the article is present in the plurality of rack storage areas includes:
performing edge recognition on the zone by using image data received from the camera at predetermined monitoring intervals; and
determining which of the plurality of rack storage areas the recognized edge corresponds to.

15. The method of claim 14, wherein determining which of the plurality of rack storage areas the recognized edge corresponds to includes:
generating an object recognition rate that is a ratio of a size defined by a corresponding edge to a size of a rack storage area in an initial state of each of the plurality of rack storage areas;
determining that the article is present in each of the rack storage areas when the object recognition rate within each rack storage area is equal to or greater than a predetermined threshold; and
determining that the article is not present in each of the rack storage areas when the object recognition rate is less than a predetermined threshold.

16. The method of claim 15, wherein determining which of the plurality of rack storage areas the recognized edge corresponds to further includes:
determining that the article is present in any one of the plurality of rack storage areas when the recognized edge corresponding to any one of the plurality of rack storage areas is maintained for a predetermined period of time.

17. The method of claim 15, wherein determining which of the plurality of rack storage areas the recognized edge corresponds to further includes:
calculating an object recognition rate in each rack storage area for the recognized edge when the recognized edge is located over two rack storage areas of the plurality of rack storage areas; and
determining that the article is present in the rack storage area of the two rack storage areas with a higher object recognition rate.

18. The method of claim 12, wherein checking the inventory status of the plurality of rack storage areas includes:
comparing the article recognition result by the computing device with the rack inventory status stored in the database;
determining that the rack inventory status is normally tracked when the article recognition result received from the computing device matches the rack inventory status stored in the database as a result of the comparison; and
notifying a terminal of a worker who has performed work on the mismatched rack storage area of a work error when the article recognition result received from the computing device does not match the rack inventory status stored in the database as a result of the comparison.

19. The method of claim 18, further comprising:
storing a work error history for each worker, and notifying an administrator terminal of a repeat of a work error of a specific worker when the specific worker repeats a work error a predetermined number of times or more.

20. A non-transitory computer readable medium containing program instructions executed by a processor, the computer readable medium comprising:
program instructions that distinguish a plurality of rack storage areas in an image acquired from a camera;
program instructions that perform object recognition on the plurality of rack storage areas to determine whether an article is present in the plurality of rack storage areas; and
program instructions that check an inventory status of the plurality of rack storage areas by comparing the presence of the article in the plurality of rack storage areas with a rack inventory status stored in a database.
